(19) United States
(12) Patent Application Publication
(10) Pub. No.: US 2008/0093470 A1
(43) Pub. Date: Apr. 24, 2008

(54) CONSTANT TEMPERATURE VALVE CORE WITH DUAL STEMS AND DUAL FUNCTIONS

(76) Inventor: Xie Qingjun, Guangdong (CN)

Correspondence Address: JOHN CHEN, ROOM 303, 3F, NO. 25, SEC. 1, CHANGAN E. ROAD, TAIPEI, 10441, omitted

(21) Appl. No.: 11/614,065

(22) Filed: Dec. 20, 2006

(30) Foreign Application Priority Data
Oct. 19, 2006 (CN) PCT/CN06/02762

(51) Int. Cl. G05D 23/13

(52) U.S. Cl. 236/12.16; 236/12.2

(57) ABSTRACT

A constant temperature valve core with dual stems and dual functions is provided. The constant temperature valve core with dual stems and dual functions includes a valve body, a return spring, a regulator, a water mixer, a temperature sensor, and a temperature regulating assembly. The return spring, the regulator, the water mixer, the temperature sensor, and the temperature regulating assembly are sequentially disposed in the valve body. The constant temperature valve core with dual stems and dual functions further includes a sheath and a flow rate adjusting assembly. The sheath is arranged around the valve body, and the flow rate adjusting assembly is slidably disposed between the sheath and the valve body. The present invention scientifically integrates the constant temperature function and the flow rate control function in a single valve core, so as to overcome the defect that a conventional constant temperature valve core has only one function and can be used only when being combined with other valve cores. Moreover, the present invention has the advantages of providing stable output water temperature, being safe and convenient, and easy to operate.

### BACKGROUND OF THE INVENTION

1. Field of the Invention

The present invention relates to a valve core. More particularly, the present invention relates to a constant temperature valve core with dual stems and dual functions.

2. Description of Related Art

China Patent Publication No. CN2703176A discloses a constant temperature valve core, which includes a valve stem, a collar, a hold down bolt, a buffer spring, an adjusting bolt, a top cap, a filter mesh, a regulator, a thermal sensitive element, a valve core body, and a valve body. A water mixer is arranged on a stem portion of the thermal sensitive element. The water mixer is pressed against a head portion of the thermal sensitive element. The return spring is arranged on a cylinder at a lower end of the water mixer. The other end of the return spring is pressed against an inner boss of the valve body. The constant temperature valve core realizes the function of constant temperature control through the cooperation of the elements such as the buffer spring, adjusting bolt, top cap, regulator, and thermal sensitive element. However, the constant temperature valve core has the defects that the flow rate control function is not achieved, i.e., the flow rate of the output water cannot be controlled.

### SUMMARY OF THE INVENTION

The present invention is directed to provide a constant temperature valve core with dual stems and dual functions, which has the functions of constant temperature control and output flow rate control.

To achieve the aforementioned objective, the constant temperature valve core with dual stems and dual functions comprises a valve body, a return spring, a regulator, a water mixer, a temperature sensor, and a temperature regulating assembly, wherein a cold water inlet, a hot water inlet, and a water outlet are opened at different heights in the valve body, and the return spring, the regulator, the water mixer, the temperature sensor, and the temperature regulating assembly are sequentially disposed in the valve body; one end of the return spring is pressed against the valve body, and the other end is connected to the regulator; the regulator is slidably disposed between the cold water inlet and the hot water inlet, the water mixer is connected to the water mixer, and the temperature sensor touches the water mixer; one end of the temperature regulating assembly is connected to the temperature sensor, and the other end extends outside the valve body. The constant temperature valve core with dual stems and dual functions further comprises an sheath and a flow rate adjusting assembly, wherein a water outlet is opened in the sheath at a position corresponding to the water outlet of the valve body; the sheath is arranged around the valve body, and spaced from the valve core body to form an interval, and the flow rate adjusting assembly is disposed in the interval.

As embodied and broadly described herein, the present invention scientifically integrates the constant temperature and flow rate control functions in a single valve core, so as to overcome the defect that the conventional constant valve core has only one function and can be used only when being combined with other valve cores. Therefore, the present invention has the advantages of providing stable output water temperature as the water supply temperature or pressure has little influence on the output water temperature, being safe and reliable, and easy to operate.

### BRIEF DESCRIPTION OF THE DRAWINGS

FIG. 1 is a sectional structural view of the present invention;

FIG. 2 is a profile of the present invention;

FIG. 3 is a partial sectional view of the water mixer of the present invention;

FIG. 4 is a top view of the water mixer of the present invention in FIG. 3; and

FIG. 5 is a bottom view of the water mixer of the present invention in FIG. 3.

### DESCRIPTION OF EMBODIMENTS

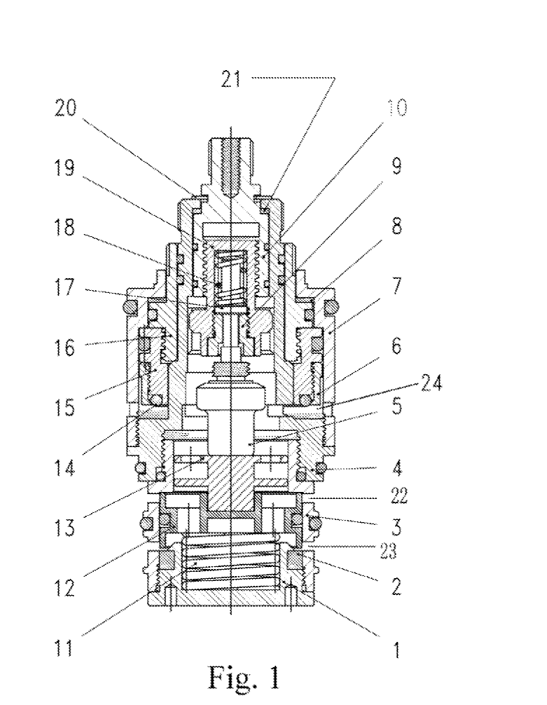

As shown in FIG. 1, the valve core with dual stems and dual functions includes a base 1, a gasket 2, a constant temperature valve sheath 3, a valve core body 4, a temperature sensor 5, a sealing ring hold down nut 6, a sheath 7, an abrasion resistant pad 8, a push rod base 9, a temperature regulating valve stem 10, a return spring 11, a regulator 12, a water mixer 13, a sealing ring 14, a flow rate adjusting slide valve 15, a flow rate adjusting bolt 16, a push rod 17, a safety spring 18, a collar 20, and O-rings of various specifications.

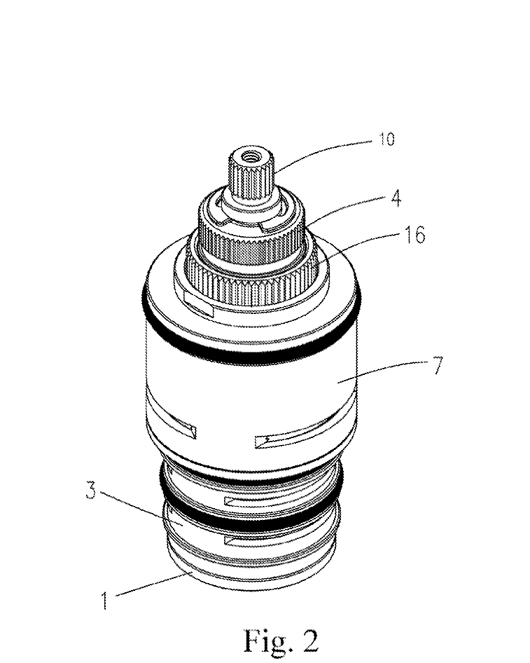

The details and connection of the above elements are described below with reference to FIGS. 1 and 2. The base 1, the constant temperature valve sheath 3, and the valve core body 4 are sequentially connected to form a valve body. The gasket 2 is disposed between the base 1 and the constant temperature valve sheath 3, a cold water inlet 22 and a hot water inlet 23 are opened at different heights in the constant temperature valve sheath 3, and a water outlet 24 is opened in the valve core body 4. The return spring 11, the regulator 12, the water mixer 13, the temperature sensor 5, the push rod base 9, the temperature regulating valve stem 10, the push rod 17, the safety spring 18, a temperature regulating bolt 19, and a lubricating pad 21 are disposed in the valve body composed of the base 1, the constant temperature valve sheath 3, and the valve core body 4. One end of the return spring 11 is pressed against the base 1, and the other end is connected to the regulator 12. The regulator 12 is slidably disposed between the cold water inlet 22 and the hot water inlet 23. The water mixer 13 is connected to the regulator 12. One end of the temperature sensor 5 touches the water mixer 13, and the other end is connected to the push rod 17. The push rod base 9 is arranged on one end of the push rod 17, and the safety spring 18 is arranged on the other end of the push rod 17. The temperature regulating bolt 19 is further arranged outside the push rod base 9 and the safety spring 18. The temperature regulating stem 10 is disposed outside the temperature regulating bolt 19, and the lubricating pad 21 is disposed between the temperature regulating valve stem 10 and the valve core body 4. One end of the temperature regulating valve stem 10 extends to the outside from another opening end of the valve core body, and the collar 20 is arranged on one end of the temperature regulating valve stem 10 and is disposed outside the valve core body 4. A water outlet is opened in the sheath 7 at a position corresponding to the water outlet of the valve core body 4. The sheath 7 is arranged around the valve core body 4, and spaced from the valve core body 4 to form an interval. The adjusting bolt 16, the flow rate adjusting slide valve 15 controlled by the adjusting bolt 16 to slide in the interval, and the sealing ring hold down nut 6 are disposed in the interval. The sealing ring hold down nut 6 is connected to one side of the flow rate adjusting slide valve 15, and the sealing ring 14 is disposed between the sealing ring hold down nut 6 and the flow rate adjusting slide valve 15. The abrasion resistant pad 8 is disposed between the flow rate adjusting bolt 16 and the sheath 7.

As described above, the push rod base 9, the temperature regulating valve stem 10, the push rod 17, the safety spring 18, the temperature regulating bolt 19, and the lubricating pad 21 form a temperature regulating assembly. The temperature regulating assembly, after being connected to the temperature sensor 5, is adjusted to set the desired constant temperature. The sealing ring hold down nut 6, the abrasion resistant pad 8, the sealing ring 14, the flow rate adjusting slide valve 15, and the flow rate adjusting bolt 16 form a flow rate adjusting assembly that is adjusted to control the flow rate of the output water.

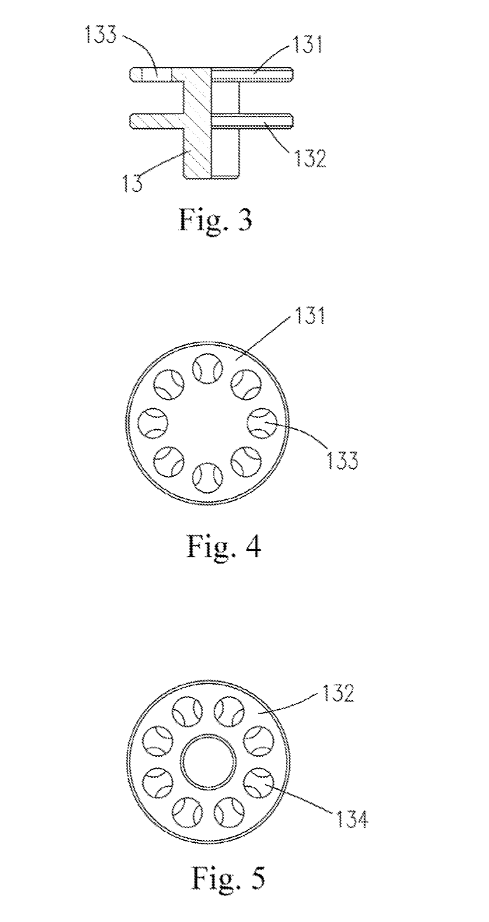

Referring to FIGS. 3, 4, and 5, the water mixer 13 of the present invention includes two water passage layers 131, 132, and a plurality of water passage holes 133, 134 are evenly opened in the two water passage layers 131, 132 respectively. The water passage holes 133 in the upper layer and the water passage holes 134 in the lower layer are staggeredly arranged. Thus, the supplied water is well mixed, and the upstream temperature sensing element has better conditions for monitoring. Therefore, the present invention has the advantage of providing stable output water temperature as the water supply temperature or pressure has little influence on the output water temperature.

In use, the desired constant temperature is set with the temperature regulating assembly first, i.e., the proportion of input from the cold water inlet 22 and the hot water inlet 23 is set first, and the cold and hot water is input at a certain proportion and then well mixed with the mixer 13. The temperature sensor 5, when sensing the temperature in the water mixer 13, controls the movement of the regulator 12, so as to control the proportion of the input from the cold and hot water inlets, such that the output water temperature maintains constant. In some special situations, e.g., when the temperature sensor 5 detects an accident that the cold water supply is suddenly interrupted in use, the temperature sensor 5 will expand rapidly to urge the regulator 12 moving downward to be attached to the rubber gasket 2. Thus, the slit for hot water supply is completely shut down, and the entire valve core stops supplying water. The mixed water flows out from the water outlet 24 of the valve core body 4 and the sheath 7. The flow rate is controlled by turning the flow rate adjusting bolt 16 to make the flow rate adjusting slide valve 15 moving upward and downward to change the size of the water outlet slit. The sealing ring 14 disposed between the flow rate adjusting slide valve 15 and the sealing ring hold down nut 6 is used for preventing the mixed output water from flowing out of the valve.

As described above, the present invention includes the temperature sensor and the regulator. After the temperature regulating assembly sets a temperature, the temperature sensor, when sensing the temperature of the water mixer, controls the movement of the regulator, so as to control the proportion of input from the cold and hot water inlets, such that the output water temperature maintains constant. In addition, the present invention has a flow rate control assembly, and the flow rate of the output water can be controlled conveniently by adjusting the flow rate control assembly. Thus, the present invention overcomes the defect that the conventional constant temperature valve core has only one function and can be used only by being combined with other valve cores. Therefore, the present invention has the advantages of providing stable output water temperature as the water supply temperature or pressure has little influence on the output water temperature, being safe and reliable, and easy to operate.

### LIST OF REFERENCE NUMBERS

1 Base

2 Gasket

3 Constant Temperature Valve Sheath

4 Valve Core Body

5 Temperature Sensor

6 Sealing Ring Hold Down Nut

7 Sheath

8 Abrasion resistant pad

9 Push Rod Base

10 Temperature Regulating Valve Stem

11 Return Spring

12 Regulator

13 Water Mixer

14 Sealing Ring

15 Flow Rate Adjusting Slide Valve

16 Flow Rate Adjusting Bolt

17 Push rod

18 Safety Spring

19 Temperature Regulating Bolt

20 Collar

21 Lubricating Pad

22 Cold Water Inlet

23 Hot Water Inlet

24 Water Outlet

131, 132 Water Passage Layer

133, 134 Water Passage Hole

What is claimed is:

1. A constant temperature valve core with dual stems and dual functions, comprising a valve body, a return spring, a regulator, a water mixer, a temperature sensor, and a temperature regulating assembly, wherein a cold water inlet, a hot water inlet, and a water outlet are opened at different heights in the valve body, and the return spring, the regulator, the water mixer, the temperature sensor, and the temperature regulating assembly are sequentially disposed in the valve body; one end of the return spring is pressed against the valve body, and the other end is connected to the regulator; the regulator is slidably disposed between the cold water inlet and the hot water inlet; the water mixer is connected to the regulator; the temperature sensor touches the water mixer, and one end of the temperature regulating assembly is connected to the temperature sensor, and the other end extends outside the valve body; the constant temperature valve core with dual stems and dual functions further comprising an sheath and a flow rate adjusting assembly, wherein a water outlet is opened in the sheath at a position corresponding to water outlet of the valve body, the sheath is arranged around the valve body, and spaced from the valve body to form an interval, and the flow rate adjusting assembly is disposed in the interval.

2. The constant temperature valve core with dual stems and dual functions as claimed in claim 1, wherein the valve body comprises a base, a constant temperature valve sheath, and a valve core body, and the base, the constant temperature valve sheath, and the valve core body are connected sequentially to form the valve body.

3. The constant temperature valve core with dual stems and dual functions as claimed in claim 2, wherein the cold water inlet and the hot water inlet are opened at different heights in the constant temperature valve sheath.

4. The constant temperature valve core with dual stems and dual functions as claimed in claim 3, wherein the water outlet is opened in the valve core body.

5. The constant temperature valve core with dual stems and dual functions as claimed in claim 1, wherein the temperature regulating assembly comprises a push rod base, a temperature regulating valve stem, a push rod, a safety spring, and a temperature regulating bolt, in which the push rod base is arranged on one end of the push rod, and the safety spring is arranged on the other end of the push rod, the temperature regulating bolt is arranged outside the push rod base and the safety spring, the valve stem is disposed outside the temperature regulating bolt, and one end of the temperature regulating valve stem extends outside the valve core body.

6. The constant temperature valve core with dual stems and dual functions as claimed in claim 1, wherein the flow rate adjusting assembly comprises an adjusting bolt, a flow rate adjusting slide valve connected to and controlled by the adjusting bolt to slide in the interval, and a seal ring hold down nut, in which the sealing ring hold down nut is connected on one side of the flow rate adjusting slide valve, and a sealing ring is disposed between the sealing ring hold down nut and the flow rate adjusting slide valve.

7. The constant temperature valve core with dual stems and dual functions as claimed in claim 1, wherein a gasket is disposed between the base and the constant temperature valve sheath.

8. The constant temperature valve core with dual stems and dual functions as claimed in claim 1, wherein the water mixer comprises an upper water passage layer and a lower water passage layer, a plurality of water passage holes is evenly opened in the upper and lower water passage layers, in which the water passage holes in the upper layer and the water passage holes in the lower layer are staggeredly arranged.

9. The constant temperature valve core with dual stems and dual functions as claimed in claim 1, wherein a lubricating pad is disposed between the temperature regulating assembly and the valve core body.

10. The constant temperature valve core with dual stems and dual functions as claimed in claim 1, wherein an abrasion resistant pad is disposed between the flow rate adjusting assembly and the sheath.
